(19) United States
(12) Patent Application Publication
(10) Pub. No.: US 2015/0346961 A1
(43) Pub. Date: Dec. 3, 2015

(54) METHOD, APPARATUS AND COMPUTER PROGRAM PRODUCT FOR PROVIDING A RECOMMENDATION FOR AN APPLICATION

(71) Applicant: NOKIA CORPORATION, Espoo (FI)

(72) Inventors: David CUI, Beijing (CN); Herrick SHEN, Beijing (CN); Song LIU, Beijing (CN); Christian KRAFT, Bangkok (TH); Zhuoyuan LIAO, Beijing (CN)

(21) Appl. No.: 14/655,050

(22) PCT Filed: Dec. 24, 2012
(86) PCT No.: PCT/CN2012/087344

§ 371 Date: Jun. 23, 2015

(51) Int. Cl. G06F 3/0484; G06F 3/0488; G06F 3/0481

(52) U.S. Cl. CPC G06F 3/04842; G06F 3/04817; G06F 3/0488

(57) ABSTRACT

Provided herein are a method, apparatus and computer program product for providing a recommendation for an application in response to determining that an application that was initiated was not an intended application. In particular, methods may include receiving a first input corresponding to the initiation of a first application, initiating the first application in response to receiving the first input, receiving an indication of a closure of the first application, and determining that the closure of the first application occurred meeting one or more predetermined conditions. The method may cause a recommendation to be provided of at least a second application in response to determining that the closure of the first application occurred meeting one or more predetermined conditions.

### TECHNOLOGICAL FIELD

Example embodiments of the present invention relate generally to a user interface of a device, and more particularly, to a method, apparatus, or computer program product to enable a user to easily select an alternative, recommended application in response to an application having been initiated that was unintended.

### BACKGROUND

The modern communications era has brought about a tremendous expansion of wireline and wireless networks. Computer networks, television networks, and telephone networks are experiencing an unprecedented technological expansion, fueled by consumer demand. Wireless and mobile networking technologies have addressed consumer demands while providing more flexibility and immediacy of information transfer.

Mobile devices, such as cellular telephones, have become smaller and lighter while also becoming more capable of performing tasks that far exceed a traditional voice call. Mobile devices are becoming small, portable computing devices that are capable of running a variety of applications, some of which benefit from a larger display. These devices are comparable in capabilities to laptop or desktop-type computers such that they can execute thousands of available applications. The portability of such devices may be enhanced by reducing their size, and hence, their display size. Limited display size may limit the available area in which inputs, such as tiles, may be displayed, particularly in embodiments including touch screen inputs where the tile may receive input from a user. Therefore, small displays may be conducive to accidental and unintended inputs. Further, with the increasing number of functions and applications available on a device, a user may inadvertently or incorrectly select a function or application.

### SUMMARY

In general, an example embodiment of the present invention provides a mechanism for recommending an application to a user in response to determining that an application was previously initiated by mistake. In particular, a method of example embodiments may include receiving a first input corresponding to the initiation of a first application, initiating the first application in response to receiving the first input, receiving an indication of a closure of the first application, and determining that the closure of the first application occurred meeting one or more predetermined conditions. The method may cause a recommendation to be provided of at least a second application in response to determining that the closure of the first application occurred meeting one or more predetermined conditions. One of the one or more predetermined conditions may include that no functions of the first application were executed between the initiation of the first application and the indication of the closure of the first application. One of the one or more predetermined conditions may include receiving an indication of a closure of the first application within a predetermined time of receiving the first input corresponding to the initiation of the first application.

According to some embodiments of a method of the present invention, causing a recommendation to be provided of at least a second application in response to determining that the closure of the first application occurred meeting one or more predetermined conditions may include determining that the second application is at least one of: an application that performs a similar function as the first application, an application comprising a tile that is similar to a tile of the first application; an application with a name similar to a name of the first application, or proximity of a tile representing the first application to a tile representing the second application. Receiving an input corresponding to the initiation of a first application may include receiving an indication of selection of a tile corresponding to the first application, and causing a recommendation to be provided of at least a second application in response to determining that the closure of the first application occurred meeting one or more predetermined conditions may include providing for display of at least a tile corresponding to at least the second application. Methods of example embodiments may further include receiving a second input, and causing a recommendation to be provided of at least a second application in response to the second input.

According to further embodiments of a method of the present invention, the method may further include determining that the first application had previously been closed, where the previous closure occurred meeting one or more predetermined conditions, where causing a recommendation to be provided of at least a second application may include causing a recommendation to be provided of at least a second application that corresponds to an application that was initiated in response to the first application previously being closed where the closure occurred meeting one or more predetermined conditions. According to some embodiments, receiving a first input corresponding to the initiation of a first application may include receiving a selection of a file to be opened.

Example embodiments of the invention may provide an apparatus including at least one processor and at least one memory including computer program code. The at least one memory and the computer program code configured to, with the at least one processor, cause the apparatus to receive a first input corresponding to the initiation of a first application, initiate the first application in response to receiving the first input, receive an indication of a closure of the first application, and determine that the closure of the first application occurred meeting one or more predetermined conditions. The application may further cause a recommendation to be provided of at least a second application in response to determining that the closure of the first application occurred meeting one or more predetermined conditions. One of the one or more of the predetermined conditions may include that no functions of the first application were executed between the initiation of the first application and the indication of the closure of the first application. One of the one or more of the predetermined conditions may include receiving an indication of a closure of the first application within a predetermined time of receiving the first input corresponding to the initiation of the first application. Causing a recommendation to be provided of at least a second application in response to determining that the closure of the first application occurred meeting one or more predetermined conditions may include causing the apparatus to determine that the second application is at least one of: an application that performs a similar function as the first application, an application comprising a tile that is similar to a tile of the first application; an application with a name similar to a name of the first application, or proximity of a tile representing the first application to a tile representing the second application.

An apparatus according to example embodiments of the present invention may further be caused to determine that the first application had previously been closed, where the previous closure occurred meeting one or more predetermined conditions, where causing the apparatus to cause a recommendation to be provided of at least a second application may include causing the apparatus to cause a recommendation to be provided of at least a second application that corresponds to an application that was initiated in response to the first application previously being closed where the closure occurred meeting one or more predetermined conditions. Causing the apparatus to receive an input corresponding to the initiation of a first application may include causing the apparatus to receive an indication of selection of a tile corresponding to the first application, where causing the apparatus to cause a recommendation to be provided of at least a second application in response to determining that the closure of the first application occurred meeting one or more predetermined conditions includes causing the apparatus to provide for display of at least a tile corresponding to at least the second application. Causing the apparatus to receive a first input corresponding to the initiation of a first application may include causing the apparatus to receive selection of a file to be opened. An apparatus according to example embodiments may be caused to receive a second input, and cause a recommendation to be provided of at least a second application in response to the second input.

Embodiments of the present invention may provide a computer program product including at least one non-transitory, computer-readable storage medium having computer executable program code instructions stored therein. The computer executable program code instructions may include program code instructions for receiving a first input corresponding to the initiation of a first application, program code instructions for initiating the first application in response to receiving the first input, program code instructions for receiving an indication of a closure of the first application, and program code instructions for determining that the closure of the first application occurred meeting one or more predetermined conditions. Example embodiments of the computer program product may further include program code instructions for causing a recommendation to be provided of at least a second application in response to determining that the closure of the first application occurred meeting one or more predetermined conditions. One of the one or more predetermined conditions may include that no functions of the first application were executed between the initiation of the first application and the indication of the closure of the first application. One of the one or more predetermined conditions may include receiving an indication of a closure of the first application within a predetermined time of receiving the first input corresponding to the initiation of the first application.

A computer program product according to example embodiments of the present invention may further include program code instructions for determining that the first application had previously been closed, where the previous closure occurred meeting one or more predetermined conditions, where the program code instructions for causing a recommendation to be provided of at least a second application includes program code instructions for causing a recommendation to be provided of at least a second application that corresponds to an application that was initiated in response to the first application previously being closed where the closure occurred meeting one or more predetermined conditions. The program code instructions for causing a recommendation to be provided of at least a second application in response to determining that the closure of the first application occurred meeting one or more predetermined conditions includes program code instructions for determining that the second application is at least one of an application that performs a similar function as the first application, an application comprising a tile that is similar to a tile of the first application; an application with a name similar to a name of the first application, or proximity of a tile representing the first application to a tile representing the second application. The program code instructions for receiving an input corresponding to the initiation of a first application may include program code instructions for receiving an indication of selection of a tile corresponding to the first application. The program code instructions for causing a recommendation to be provided of at least a second application in response to determining that the closure of the first application occurred meeting one or more predetermined conditions may include program code instructions for providing for display of at least a tile corresponding to at least the second application. A computer program product of example embodiments may further include program code instructions for receiving a second input, and program code instructions for causing a recommendation to be provided of at least a second application in response to the second input.

Example embodiments of the invention may provide an apparatus including means for receiving a first input corresponding to the initiation of a first application, means for initiating the first application in response to receiving the first input, means for receiving an indication of a closure of the first application, and means for determining that the closure of the first application occurred meeting one or more predetermined conditions. The apparatus may further include means for causing a recommendation to be provided of at least a second application in response to determining that the closure of the first application occurred meeting one or more predetermined conditions. One of the one or more predetermined conditions may include that no functions of the first application were executed between the initiation of the first application and the indication of the closure of the first application. One of the one or more predetermined conditions may include receiving an indication of a closure of the first application within a predetermined time of receiving the first input corresponding to the initiation of the first application.

An apparatus according to example embodiments of the present invention may further include means for causing a recommendation to be provided of at least a second application in response to determining that the closure of the first application occurred meeting one or more predetermined conditions includes means for determining that the second application is at least one of: an application that performs a similar function as the first application, an application comprising a tile that is similar to a tile of the first application; an application with a name similar to a name of the first application, or proximity of a tile representing the first application to a tile representing the second application. The means for receiving an input corresponding to the initiation of a first application may include means for receiving an indication of selection of a tile corresponding to the first application, and the means for causing a recommendation to be provided of at least a second application in response to determining that the closure of the first application occurred meeting one or more predetermined conditions may include means for providing for display of at least a tile corresponding to at least the second application.

An apparatus according to example embodiments of the present invention may further include means for determining that the first application had previously been closed, where the previous closure occurred meeting one or more predetermined conditions, where means for causing a recommendation to be provided of at least a second application may include means for causing a recommendation to be provided of at least a second application that corresponds to an application that was initiated in response to the first application previously being closed where the closure occurred meeting one or more predetermined conditions. According to some embodiments, the means for receiving a first input corresponding to the initiation of a first application may include means for receiving a selection of a file to be opened. An apparatus of example embodiments may further include means for receiving a second input, and means for causing a recommendation to be provided of at least a second application in response to the second input.

### DRAWINGS

Having thus described certain embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing a mechanism by which a recommendation for an application may be provided according to an example embodiment of the present invention;

FIG. 3 is an illustration of a device displaying a plurality of a tiles on a touch screen interface according to an example embodiment of the present invention;

FIG. 4 is an illustration of a device displaying a plurality of tiles on a touch screen interface according to another example embodiment of the present invention;

FIG. 5 is an illustration of an initiated application presented on the display of a device according to an embodiment of the present invention;

FIG. 6 is an illustration of presentation of recommendations for applications according to an example embodiment of the present invention;

FIG. 7 is an illustration of an initiated application presented on the display of a device according to another embodiment of the present invention;

FIG. 8 is an illustration of presentation of recommendations for applications according to another example embodiment of the present invention; and

FIG. 9 is a flowchart of a method for providing recommendations for applications according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Devices that may benefit from example embodiments of the present invention may include portable devices, such as tablet computers, cellular telephones, portable media devices, or the like, which are enhanced by a graphical user interface presented on a display, such as a touch screen. As portability of these devices often relates to their size, a smaller size may enhance portability while potentially sacrificing the available display area. Such devices may include a large number of applications and functions to perform a variety of operations. Because many applications and functions may be available, a user of the device may inadvertently, or mistakenly initiate an application or function that they do not wish to use. In some cases, the application or function may be initiated by selection of a tile, and the tile may be similar to other tiles, leading to confusion. In other cases, a user may initiate an application based on a name or type of application. Upon initiating the application, the user may recognize that it was not the application that they intended to initiate. In still further cases, a user may select a file which may be opened with an application either associated with the file or the default application for that file. In such cases, the application which opens the file (e.g., a document viewer) may not be what the user intended to use to open the file (e.g., a document editor).

Embodiments of the present invention may provide a method, apparatus, and computer program product to help a user to correct the above-identified mistakes and recommend alternative applications or functions that the user may want to initiate when the previously initiated application or function is determined to be a mistake or unintentional. The determination that an application or function was initiated by mistake may be made based on the initiation and closure of the application or function meeting one or more predetermined conditions as will be described further below.

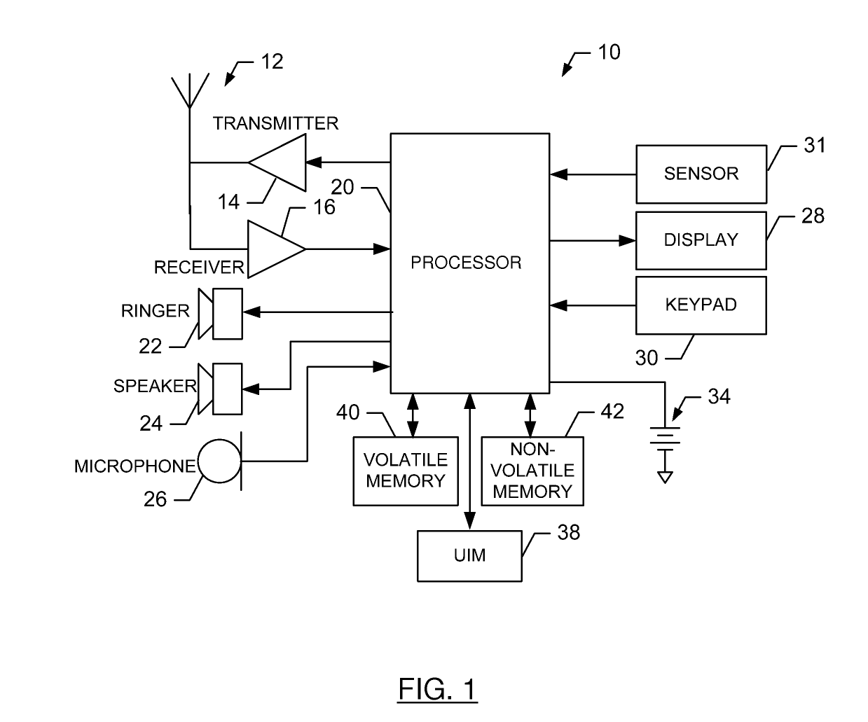

One example embodiment of the invention is depicted in FIG. 1 which illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as personal digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices (e.g., personal computers) may also employ some example embodiments.

The mobile terminal 10 may include an antenna 12 (or multiple antennas) in operable communication with a transmitter 14 and a receiver 16. The mobile terminal 10 may further include an apparatus, such as a processor 20 or other processing device, which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. Additional input to the processor 20 may include a sensor 31. The sensor 31 may include one or more of a motion sensor, temperature sensor, light sensor, accelerometer, or the like. Forms of input that may be received by the sensor may include physical motion of the mobile terminal 10, whether or not the mobile terminal 10 is in a dark environment (e.g., a pocket) or in daylight, whether the mobile terminal is being held by a user or not (e.g., through temperature sensing of a hand). The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

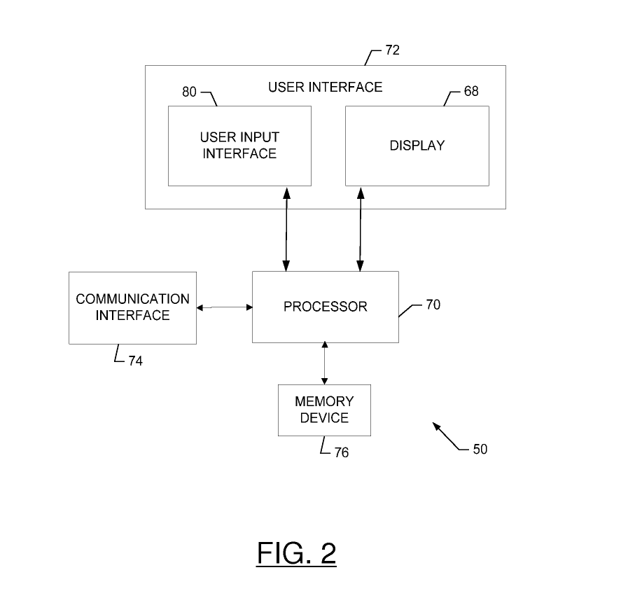

An example embodiment of the present invention will now be described with reference to FIG. 2, in which certain elements of an apparatus 50 for managing information presented on a graphical user interface are illustrated. The apparatus 50 of FIG. 2 may be a device such as mobile terminal 10 of FIG. 1. However, it should be noted that the present invention may be embodied on any number of devices that include, or are otherwise in communication with displays.

The apparatus 50 may, in some embodiments, be a mobile terminal (e.g., mobile terminal 10) as illustrated in FIG. 1 or a computing device configured to employ an example embodiment of the present invention. However, in some embodiments, the apparatus 50 may be embodied as a chip or chip set that may be in communication with ancillary devices such as a touch screen display. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user input interface 72 may be in communication with the processor 70 to receive an indication of a user input at the user interface 72 and/or to provide an audible, visual, mechanical or other output to the user. As such, the user interface 72 may include a user input interface 80, for example, a keyboard, a mouse, a joystick, a display, a touch screen(s), touch areas, device surfaces and/or sensors capable of detecting objects hovering over the surface, soft keys, a microphone, a speaker, motion sensor, temperature sensor, accelerometer, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a display, such as the illustrated display 68 (e.g., the display 28). In different example cases, the display 68 may be a two dimensional (2D) or three dimensional (3D) display and may be capable of receiving input, such as with a touch screen display. The display 68 may be embodied as any known touch screen display. Thus, for example, the display 68 could be configured to enable touch recognition by any suitable technique, such as resistive, capacitive, infrared, strain gauge, surface wave, optical imaging, dispersive signal technology, acoustic pulse recognition, etc. techniques. The user input interface 80 may be in communication with the display 68 to receive indications of user inputs at the display 68 and to modify a response to such indications based on corresponding user actions that may be inferred or otherwise determined responsive to the indications. In one alternative, a touch input may be provided other than by direct interaction with a display (e.g., in cases where the user interface is projected onto a wall with a projector, or where a cursor is used to direct input on the display).

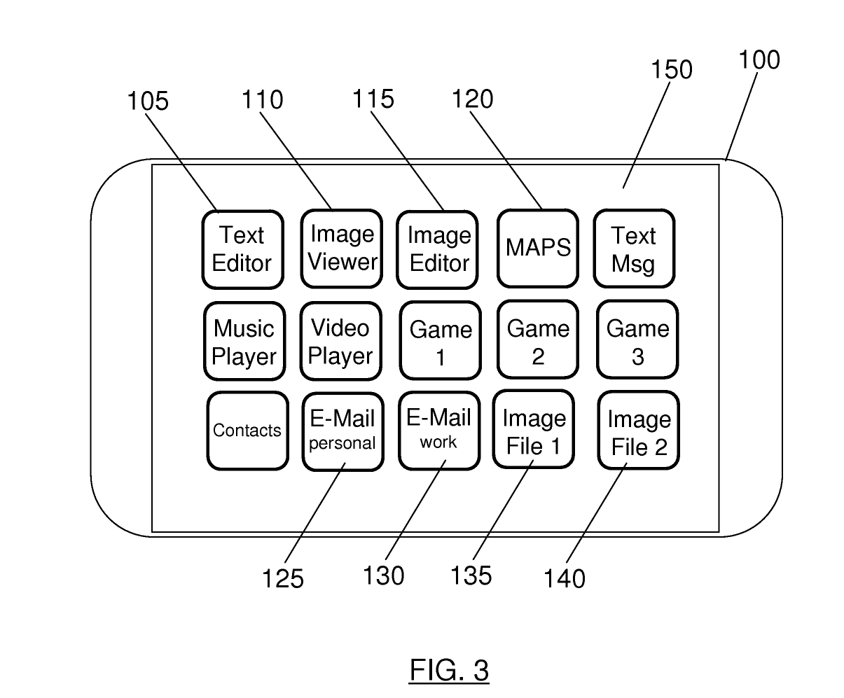

FIG. 3 depicts a device 100, such as a mobile device (e.g., mobile terminal 10), that includes a display 150 for providing a mechanism by which a recommendation for an application may be provided in response to determining that a previously initiated application was initiated in error. Devices 100 according to example embodiments of the present invention may be configured to display a user interface for an application with which a user may interact. In embodiments including a touch-screen display 150, a user may interact with the operating system to initiate applications or functions by touching areas of the display which are configured to receive user input.

The illustrated embodiment of FIG. 3 depicts a touch screen display with a plurality of tiles displayed thereon. Tiles may include icons, screen shots, text, patterns, images (video or still), or any form of distinguishing characteristic which may serve as an indicator as to an application, file, or function that is associated with the tile. For example, tile 105 represents a text editor application such that an input received proximate tile 105 may initiate the text editor application associated with tile 105. Similarly, tile 125 represents an email application, in this case, an email application linked to a personal email account. Tile 130 represents an email application that is linked to a work email account. Additional tiles (e.g., tiles 110, 115, 120, 135, 140) may also be presented on the display 150 such that a user may access the application associated with each of the tiles.

While most of the tiles depicted on the display 150 of device 100 are associated with applications, tiles 135, 140 are associated with files, such as an image file. Files may generally be opened by a number of applications. In the instant embodiment, an image file, such as a file of the Joint Photographic Experts Group (JPEG) compression format, may be opened by an image viewer, an image editor, a document editor, an email application, etc. As such, in response to an input received proximate either tile 135 or tile 140, the associated image file may be opened by an application configured to open such a file. The application may be determined by an association of the file itself or the device may be configured to open all files of a particular type with a “default” application. For example, all JPEG files, when selected, may be opened with an image viewer. Such a default application may be selected based on the amount of processing power required to run the application. An image viewer application which is not capable of image editing may consume considerably less processing power (e.g., from processor 70) than an image editor capable of performing changes to the image. Optionally, a user may configure which application is used as the “default” application to open files of particular types.

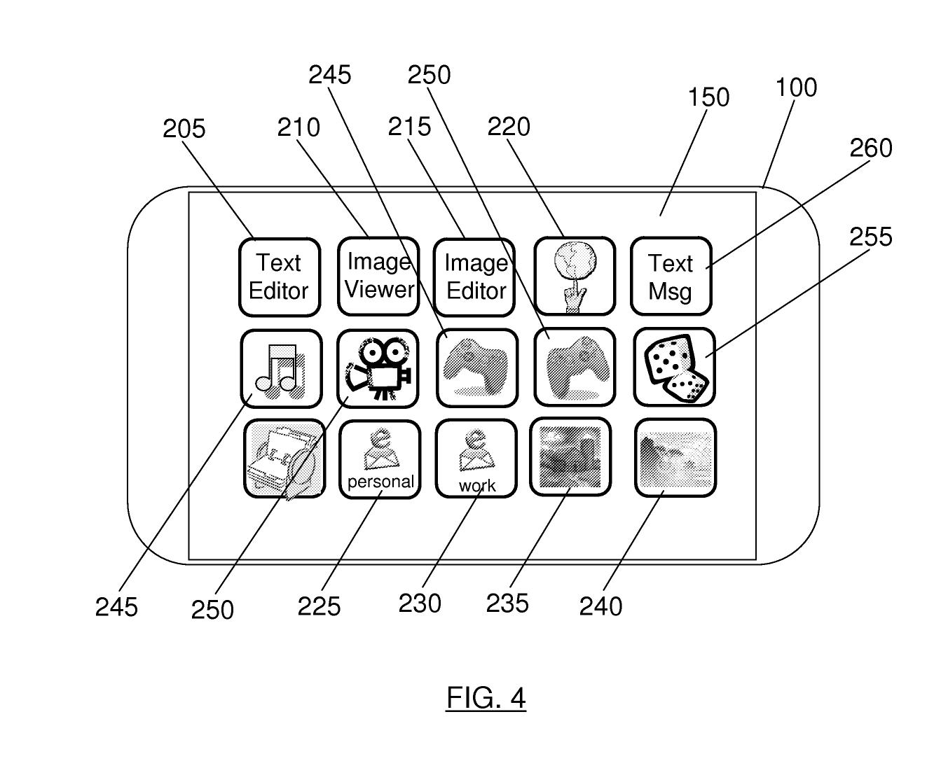

The illustrated embodiment of FIG. 3 depicts a plurality of tiles presented on a display 150 where the tiles each include a textual indicator of the file, application, or function to which they are associated. FIG. 4 illustrates a device 100 including display 150 that presents a plurality of tiles on the display, where the tiles include a variety of distinguishing features. For example, the tile 220 may be associated with a map or navigation application and is represented by a globe for intuitive understanding by a user. Tile 245 may be associated with a music player application and is represented by a music note. Tile 250 may be associated with a video recorder application and is represented by a reel-to-reel video camera illustration. Each of these graphical representations of applications may provide a user with a quick, visual way to determine which application, function, or file is associated with each tile. Image files represented by tiles 135 and 140 in FIG. 3 are illustrated in FIG. 4 where the tiles show scaled down versions or thumbnails of the image file that they represent. This may allow a user to more easily identify the file or application that they want to initiate. While the graphical representations may help a user determine the application associated with a tile, the graphical representation may not be entirely sufficient to discriminate between two similar applications. For example, tiles 225 and 230 are both associated with email applications as illustrated with the representations of an email message. However, one email application is a work email application (e.g., an email application associated with a work-based email account), while the other email application is a personal email application (e.g., an email application associated with a personal email account). As such, the two tiles are differentiated by text in addition to the email representation on the tiles.

While FIGS. 3 and 4 illustrate ways to differentiate tiles to convey to a user the applications, functions, or files that are associated with the tiles, in some cases, it may still be difficult to distinguish different tiles from one another. For example, on portable devices, such as a mobile terminal (e.g., apparatus 50), the display (e.g., display 68) may be relatively small and the tiles may consequently be small, making the tiles, including the text, images, colors, or patterns therein difficult to see. Further, many users may be “icon blind” where they see only the color or basic shape of a tile without regard for the image, pattern, or text that may be included in the tile. Further, users may be familiar with a position of a tile on the display such that upon repositioning of tiles, such as when applications are added or removed, the position changes and the user may look to the incorrect position. As there may be dozens, or even hundreds of applications, functions, or files (e.g., stored in memory 76), each with corresponding tiles, the process of selecting the correct tile for the desired application, function, or file may be particularly arduous. This may lead to mistakes by a user who may inadvertently open the wrong application, file, or function. Additionally, a user may select a tile, via user input interface 80, knowing the application that is associated with the tile, but only realizing that the application is not the one they intended to initiate after the application has been initiated. This may occur when a user, for example, opens a first file when they intended to open a second file that is similar to the first. It may also occur when a user opens a music player application (e.g., an internet radio station application) only to then determine that they intended to open a different music player application (e.g., a locally stored music player application).

Embodiments of the present invention provide a method, apparatus, and computer program product to determine when a user has initiated an application that they decide is not the application they intended to initiate, and recommending at least one alternative application to the user for ease of selection. As used herein, the term “application” is used to describe any program or function that may be initiated on a device by a user. The application may be initiated by the selection of a file, for example a music file, when selected, may initiate a music player application, or an image file, when selected, may initiate an image viewer application or a background display manager for a device.

Determining that an Application was Unintendedly Initiated

Generally, when a user initiates an application on a device, they are aware that the application is not the application they intended to initiate immediately upon selecting the application or shortly thereafter, such as when the application is initiated and presented on a display of the device. As such, in order to determine if a user initiated an application that they did not intend to initiate, embodiments of the present invention may use predetermined conditions to establish whether the application was unintended, incorrect, or otherwise not what the user wanted. Examples may use one or more of the conditions in various embodiments in order to more accurately determine if an application was initiated in error.

A first example of a predetermined condition may include where a user initiates a first application and subsequently closes the first application a short period of time after the initiation of the first application. The short period of time may be established as a threshold amount of time, such as five seconds. The threshold amount of time may be user selectable and the threshold amount of time may be application dependent. For example, an application that is a game may have a relatively short threshold amount of time as a user may quickly and easily discern that the application is not what they intended to initiate. Conversely, an email application may have a relatively longer threshold amount of time as a user may have several email accounts where they each have a resemblance, such that it is not as easy for a user to determine that the email application they initiated is not the email application they intended to initiate. As such, a first predetermined condition may include the closure of an application in under a threshold amount of time since the application was initiated.

Another example of a predetermined condition may include where a user performs no actions or functions of an application between the initiation of the application and the closure of the application. For example, if a user opens an email application, but does not compose, send, read, or otherwise perform an action or use a function of the application before closing the application, it may be determined that the email application was not an application that the user intended to initiate. As such, a second predetermined condition may include that no user initiated functions or actions of the application were executed between the initiation of the application and the closure of the application.

Further predetermined conditions may include determinations based upon signals received from sensors, such as sensor 31 of mobile terminal 10. For example, if a device includes a sensor capable of tracking the eye of a user, a determination may be made that an application that was initiated was not the application that was intended to be initiated in response to a pattern of movement of the eye as detected by the sensor. The pattern may include, for example, a quick glance or viewing only the identification of an application (e.g., through a header or menu bar of an application).

Another sensor which may be used to detect a predetermined condition may be a microphone (e.g., microphone 26 of FIG. 1) which detects an utterance by the user. For example, if upon initiation of an application, a user utters “no.” The predetermined condition may be that the utterance “no” was received by the microphone (and thereafter received at a processor, such as processor 20) after initiation of the application. The utterance may cause the application to close, or alternatively, the application may be closed in a conventional manner by a user providing an input to close the application.

A motion sensor, such as an accelerometer, may also be used to detect a predetermined condition. For example, in an embodiment which is a mobile terminal (e.g., 10 of FIG. 1), a user may shake or move the mobile terminal in a pattern to indicate that the application that was initiated was not the application the user intended to initiate. For example, upon the initiation of an application, the user may shake the device. The predetermined condition may include that the motion sensor detected a pattern of movement indicative of an application that was not intended to be initiated. The pattern of movement may include, for example, shaking, a figure-eight movement, a “bump” of the device (e.g., where the motion sensor detects an acceleration above a threshold), or the like. The pattern of movement may cause the application to close, or alternatively, the application may be closed in a conventional manner by a user providing an input to close the application.

Some applications may use different conditions or variations on the predetermined conditions to establish that the application that was initiated was not the intended application. Further, combinations of predetermined conditions may be implemented to increase the accuracy of the detection of an unintended application being initiated. For example, a determination may be made that the application was not the intended application to be initiated in response to no actions or functions of the application being performed and closure of the application within a predetermined period of time. This combination may help reduce incorrect determinations of an unintended application being initiated.

Determining Applications to Recommend

Embodiments of the present invention, in response to a closure of an application that met one or more of the predetermined conditions, may provide a recommendation of at least one other application. Under the assumption that an application was intended to be initiated, but the application that was initiated was not the intended application, one or more applications may be recommended to the user as alternatives to the application that was initiated. As such, embodiments of the invention may provide a mechanism by which recommendations for alternative applications may be made.

Recommendations for at least a second application to be provided in response to determining that closure of the first application occurred meeting one or more predetermined conditions may be made based on a number of associations or combinations of associations. For example, a first association may be a similarity between the tile selected associated with the first application and the tiles associated with other applications. An image comparison between the tiles may be performed to determine which tiles are most similar to the tile associated with the first application that was initiated in error. Referring again to FIG. 4, if the first application was the email application associated with tile 225, a recommendation for at least a second application may include the application associated with tile 230 due to the similarities in appearances of the tiles. If the first application was the game application associated with tile 245, a recommendation for at least a second application may include the application associated with tile 250 due to the similarities in appearances of the tiles.

Another association which may be made between the first application and at least a second application in order to make a recommendation may include a text comparison. Such an association may find applications with text in the tile that resembles the text in the tile associated with the first application. In the illustrated embodiment of FIG. 4, if a user selects as the first application tile 210 associated with an “Image Viewer,” and closes the application meeting one or more of the predetermined conditions, a recommendation for at least a second application may include the application associated with tile 215 as the text of tile 210 of “Image Viewer” is similar to the text of tile 215 of “Image Editor.”

A further association which may be made between the first application and at least a second application in order to make a recommendation may include a functionality comparison. Such an association may find applications with a similar function to the first application. For example, referring again to the embodiment of FIG. 4, if a user selects tile 250 to initiate the first application associated with tile 250, and subsequently closes the first application meeting one or more predetermined conditions, a recommendation of at least a second application may include the application associated with tile 255. While tile 250 and tile 255 do not bear significant resemblance, the applications associated with tile 250 and 255 may be similar, such as two games, or more specifically, two games of the same genre, such that the functionality of the two applications is similar.

Another association which may be made between the first application and at least a second application in order to make a recommendation may include a historical correlation. For example, if the first application which is opened is closed meeting one or more predetermined conditions, embodiments of the invention may determine if the same application had previously been closed meeting one or more predetermined conditions. If the application has previously been closed meeting one or more predetermined conditions, a determination may be made as to which application was selected subsequent to the first application in response to being closed meeting one or more predetermined conditions. This subsequent application may be provided as a recommendation because a user of the device has previously initiated this subsequent application in response to the first application being closed meeting one or more predetermined conditions.

A still further association which may be made between the first application and at least a second application in order to make a recommendation may include a recently or most frequently used application. For example, if a first application is initiated and subsequently closed meeting one or more predetermined conditions, a recommendation of at least a second application may be provided including the most recently or most frequently used applications. While the most frequently or most recently used applications may not be related to the first application by function, tile appearance, tile text, or historically, the most recent/frequently used applications may be recommended to the user based upon the historical use of applications on the device.

An association which may be made between the first application and at least a second application in order to make a recommendation may include proximity of the at least a second application to the first application. For example, if a first application is initiated and subsequently closed meeting one or more predetermined conditions, a recommendation of at least a second application may include applications associated with tiles that were disposed proximate to the tile associated with the first application. Such a recommendation may be made based on a user possibly selecting a tile adjacent to the tile they intended to select.

While the above associations between a first application and at least a second application for providing a recommendation in response to the closure of the first application meeting one or more predetermined conditions have been described individually, a combination of the associations may be used to provide improved recommendations for alternative applications. For example, the association of at least a second application with the first application may be made based upon a similarity of the appearance of the tile associated with the first application and at least a second application, and the function of the first application and the function of the second application. Combinations of the aforementioned associations may be implemented to establish a ranking or hierarchy of applications to be recommended in response to the closure of a first application meeting one or more predetermined conditions. In an embodiment including ranking of recommendations, only a finite number of the most relevant or highest ranked applications may be recommended. The number of recommended applications may be based on the number of applications found, based on a threshold ranking criteria, or may be based upon a defined number, such as displaying no more than three recommendations.

Providing Recommendations

As outlined above, embodiments of the present invention may provide for determining that the closure of a first application occurred meeting one or more predetermined conditions that suggest that the first application was not an application that a user intended to initiate. Embodiments further provide for recommendations of at least another application in response to determining that the closure of the first application occurred meeting one or more predetermined conditions. Those recommendations may be determined based upon a number of associations as described above. Upon determining the application(s) to recommend, the recommended applications, or tiles representing the recommended applications, may be provided for display in a manner differentiating the tiles of the recommended applications from other application tiles.

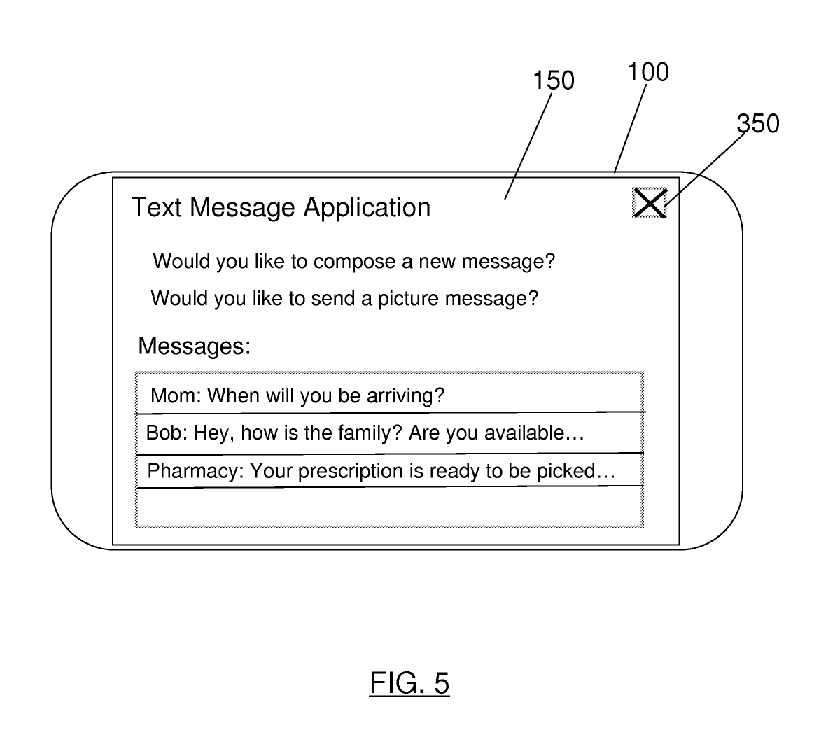

In an example scenario, an input may be received at tile 260 of FIG. 4 corresponding to the initiation of the text messaging application associated with tile 260. FIG. 5 illustrates an example embodiment of said text messaging application that may be presented to a user upon initiation of the application. A user, upon realizing that the text messaging application was not the application they intended to initiate, may close the application by providing an input proximate the closure icon 350. The closure of the text messaging application may have occurred meeting one or more predetermined conditions, such as no user initiated action or function of the text messaging application was performed and the closure occurred within five seconds of initiation of the application. A determination may then be made as to the application(s) to be recommended to the user. For example, using the association wherein the recommendations are associated with the text messaging application by function, a first email application, a second email application, and a social networking application may be recommended as alternative applications to the text messaging application.

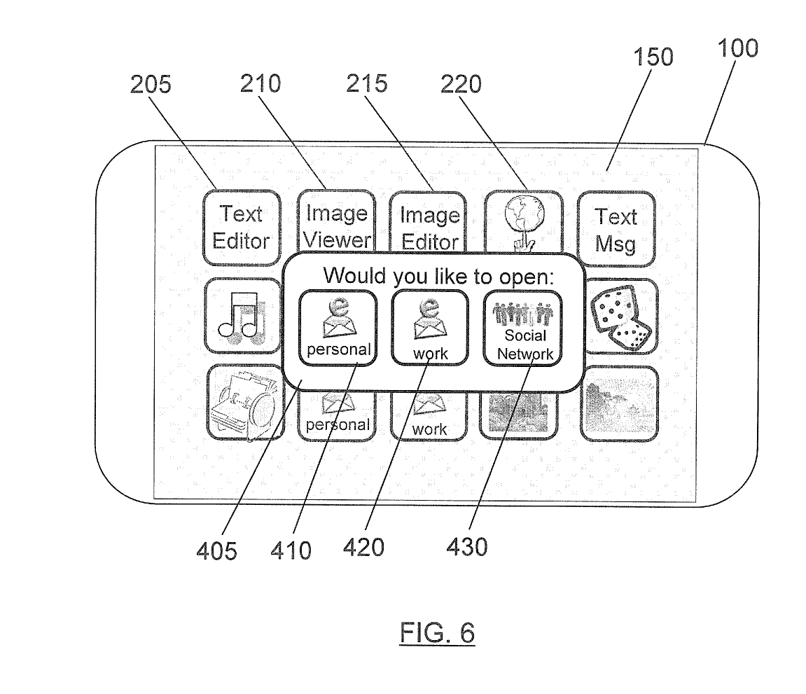

FIG. 6 illustrates an example embodiment where tiles representing the first email application 410, the second email application 420, and the social networking application 430 are provided as recommendations for alternative applications to the text messaging application in response to the text messaging application being closed meeting one or more predetermined conditions. The three tiles representing the recommended applications 410, 420, and 430 may be presented in a manner that visually distinguishes them from tiles representing applications which were not recommended. In the illustrated embodiment, the three recommended applications are presented superimposed in box 405 over the originally displayed tiles on the display 150. Further, the tiles on the display representing applications not recommended may be shown as non-selectable tiles in the background of the box 405.

FIG. 6 illustrates one example of presenting tiles representing recommended applications; however, presenting tiles representing the recommended applications may be performed in any manner that visually distinguishes the recommended applications from non-recommended applications. Alternatives include, for example, making the tiles representing the recommended applications more prominent in size, color, position, etc. and/or making the tiles representing the non-recommended application less prominent in size, color, position, transparency, etc.

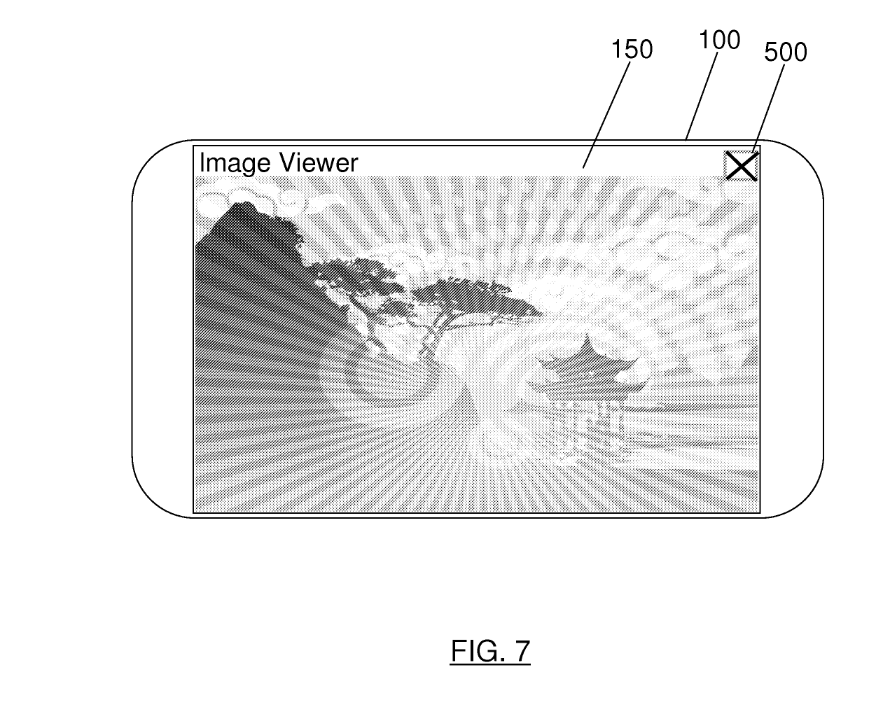

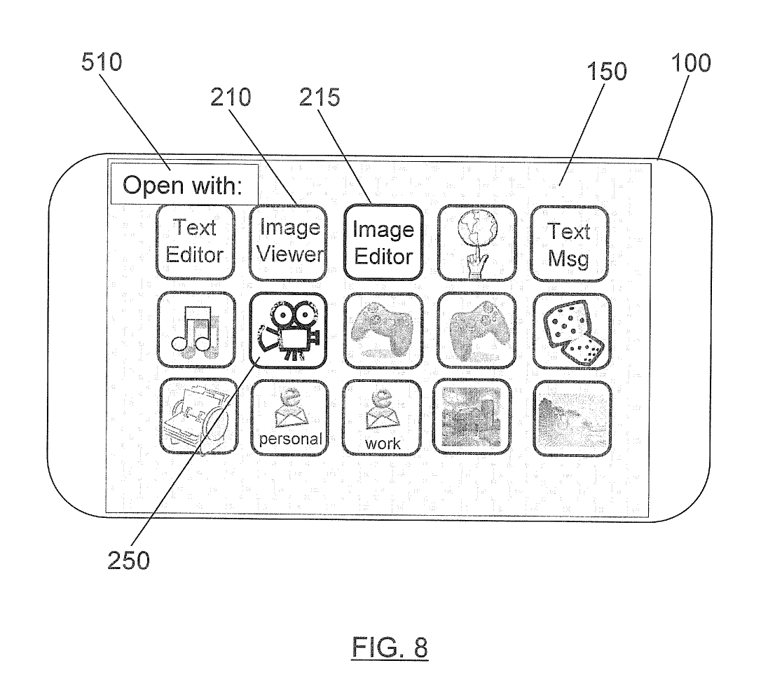

FIG. 7 illustrates an example embodiment of an image viewer application that was initiated in response to a user selecting tile 240 of FIG. 4 representing an image file. In the illustrated scenario, the user intended to open the image file of tile 240; however, the user intended to open the image using the image editor. As such, the selection of the application was not a mistake by the user, but the application which was initiated was not the application that was intended to be initiated by the user. As such, the user may close the image viewer application by providing an input at closure button 500. FIG. 8 illustrates an example embodiment of the invention in which two recommendations are provided for alternative applications with which the image file of tile 240 may be opened. The recommended applications are represented by tile 215 associated with an image editor and tile 250 associated with a video application. The remainder of the tiles, whether capable of opening the file associated with tile 240 or not, are not recommended such that they are displayed in a less prominent manner. In this case, the less prominent manner of display of the non-recommended tiles includes graying-out of the non-recommended tiles. The tiles representing the recommended applications 215, 250, are depicted in a more prominent manner by not being grayed out. Further, an indicator that the tiles represent recommended applications for opening the file associated with tile 240 is provided by text 510 which suggests that the user open the file with another application.

While the above described embodiments provide recommendations for applications in response to a first application being closed meeting one or more predetermined conditions, further example embodiments may provide recommendations for alternative applications without requiring the first application to be initiated and subsequently closed. For example, if a user had previously initiated a first application, closed the application meeting one or more predetermined conditions, and then selected a recommended application to be opened, embodiments of the invention may provide the recommended applications without requiring the user to open the first application. If the user provides a specific input, such as, for example a long-duration input (e.g., a long-press) of a tile representing the first application, recommendations for alternative applications may be presented without initiating the first application.

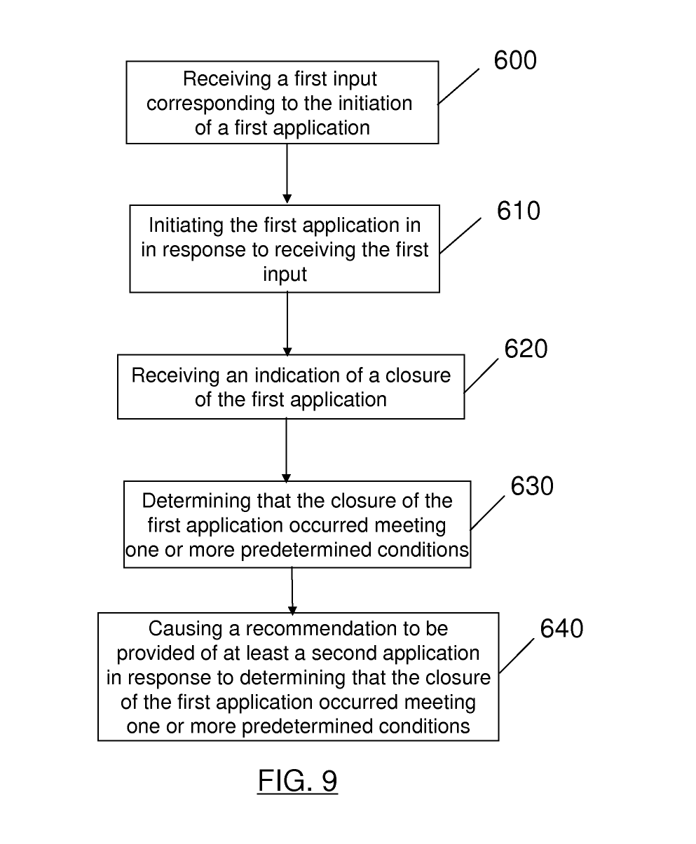

FIG. 9 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device (e.g., memory device 76 of FIG. 2) of a user device (e.g., apparatus 50) and executed by a processor (e.g., processor 70) in the user device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 9, may include receiving a first input corresponding to the initiation of a first application at 600. The first application may be initiated in response to receiving the first input at 610. An indication of a closure of the first application may be received at 620. It may be determined that the closure of the first application occurred meeting one or more predetermined conditions at 630. A recommendation may be provided of at least a second application in response to determining that the closure of the first application occurred meeting one or more predetermined conditions.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. With reference to the method of FIG. 9 in some example embodiments, one of the one or more predetermined conditions may include that no user initiated functions of the first application were executed between the initiation of the first application and the indication of the closure of the first application. Additionally or alternatively, one of the one or more predetermined conditions may include receiving an indication of a closure of the first application within a predetermined time of receiving the first input corresponding to the initiation of the first application. Additionally or alternatively, causing a recommendation to be provided of at least a second application in response to determining that the closure of the first application occurred meeting one or more predetermined conditions may include determining that the second application is at least one of: an application that performs a similar function as the first application, an application comprising a tile that is similar to a tile of the first application; an application with a name similar to a name of the first application, or proximity of a tile representing the first application to a tile representing the second application.

Embodiments of the method of FIG. 9 may additionally or alternatively include where receiving an input corresponding to the initiation of a first application includes receiving an indication of selection of a tile corresponding to the first application, and where causing a recommendation to be provided of at least a second application in response to determining that the closure of the first application occurred meeting one or more predetermined conditions includes providing for display of at least a tile corresponding to at least the second application. Additionally or alternatively, methods may include determining that the first application had previously been closed, where the previous closure occurred meeting one or more predetermined conditions, where causing a recommendation to be provided of at least a second application includes causing a recommendation to be provided of at least a second application that corresponds to an application that was initiated in response to the first application previously being closed where the closure occurred meeting one or more predetermined conditions. Additionally or alternatively, methods may include where receiving a first input corresponding to the initiation of a first application includes receiving a selection of a file to be opened.

In an example embodiment, an apparatus for performing the method of FIG. 9 above may comprise a processor (e.g., the processor 70) configured to perform some or each of the operations (600-640) described above. The processor 70 may, for example, be configured to perform the operations (600-640) by performing hardware implemented logical functions, executing stored instructions, or executing algorithms for performing each of the operations. Alternatively, the apparatus may comprise means for performing each of the operations described above.

An example of an apparatus according to an example embodiment may include at least one processor and at least one memory including computer program code. The at least one memory and the computer program code may be configured to, with the at least one processor, cause the apparatus to perform the operations 600-640 (with or without the modifications and amplifications described above in any combination).

An example of a computer program product according to an example embodiment may include at least one computer-readable storage medium having computer-executable program code portions stored therein. The computer-executable program code portions may include program code instructions for performing operations 600-640 (with or without the modifications and amplifications described above in any combination).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving a first input corresponding to the initiation of a first application;
initiating the first application in response to receiving the first input;
receiving an indication of a closure of the first application;
determining that the closure of the first application occurred meeting one or more predetermined conditions; and
causing a recommendation to be provided of at least a second application in response to determining that the closure of the first application occurred meeting one or more predetermined conditions.

2. The method according to claim 1, wherein one of the one or more predetermined conditions comprises that no user initiated functions of the first application were executed between the initiation of the first application and the indication of the closure of the first application.

3. The method according to claim 1, wherein one of the one or more predetermined conditions comprises receiving an indication of a closure of the first application within a predetermined time of receiving the first input corresponding to the initiation of the first application.

4. The method according to claim 1, wherein causing a recommendation to be provided of at least a second application in response to determining that the closure of the first application occurred meeting one or more predetermined conditions comprises determining that the second application is at least one of: an application that performs a similar function as the first application, an application comprising a tile that is similar to a tile of the first application; an application with a name similar to a name of the first application, or proximity of a tile representing the first application to a tile representing the second application.

5. The method according to claim 1, wherein receiving an input corresponding to the initiation of a first application comprises receiving an indication of selection of an tile corresponding to the first application, and wherein causing a recommendation to be provided of at least a second application in response to determining that the closure of the first application occurred meeting one or more predetermined conditions comprises providing for display of at least a tile corresponding to at least the second application.

6. The method according to claim 1, further comprising determining that the first application had previously been closed, where the previous closure occurred meeting one or more predetermined conditions, wherein causing a recommendation to be provided of at least a second application comprises causing a recommendation to be provided of at least a second application that corresponds to an application that was initiated in response to the first application previously being closed where the closure occurred meeting one or more predetermined conditions.

7. The method according to claim 1, further comprising:
receiving a second input; and
causing a recommendation to be provided of at least a second application in response to the second input.

8. An apparatus comprising at least one processor and at least one memory including computer program code, the at least one memory and the computer program code configured to, with the at least one processor, cause the apparatus to:
receive a first input corresponding to the initiation of a first application;
initiate the first application in response to receiving the first input;
receive an indication of a closure of the first application;
determine that the closure of the first application occurred meeting one or more predetermined conditions; and
cause a recommendation to be provided of at least a second application in response to determining that the closure of the first application occurred meeting one or more predetermined conditions.

9. The apparatus according to claim 8, wherein one of the one or more of the predetermined conditions comprises that no user initiated functions of the first application were executed between the initiation of the first application and the indication of the closure of the first application.

10. The apparatus according to claim 8, wherein one of the one or more of the predetermined conditions comprises receiving an indication of a closure of the first application within a predetermined time of receiving the first input corresponding to the initiation of the first application.

11. The apparatus according to claim 8, wherein causing the apparatus to cause a recommendation to be provided of at least a second application in response to determining that the closure of the first application occurred meeting one or more predetermined conditions comprises causing the apparatus to determine that the second application is at least one of an application that performs a similar function as the first application, an application comprising a tile that is similar to a tile of the first application; an application with a name similar to a name of the first application, or proximity of a tile representing the first application to a tile representing the second application.

12. The apparatus according to claim 8, wherein causing the apparatus to receive an input corresponding to the initiation of a first application comprises causing the apparatus to receive an indication of selection of a tile corresponding to the first application, and wherein causing the apparatus to cause a recommendation to be provided of at least a second application in response to determining that the closure of the first application occurred meeting one or more predetermined conditions comprises causing the apparatus to provide for display of at least a tile corresponding to at least the second application.

13. The apparatus according to claim 8, wherein the apparatus is further caused to determine that the first application had previously been closed, where the previous closure occurred meeting one or more predetermined conditions, wherein causing the apparatus to cause a recommendation to be provided of at least a second application comprises causing the apparatus to cause a recommendation to be provided of at least a second application that corresponds to an application that was initiated in response to the first application previously being closed where the closure occurred meeting one or more predetermined conditions.

14. The apparatus according to claim 8, wherein the apparatus is further caused to:
receive a second input; and
cause a recommendation to be provided of at least a second application in response to the second input.

15. A computer program product comprising at least one computer-readable storage medium having computer-executable program code instructions stored therein, the computer-executable program code instructions comprising:
program code instructions for receiving a first input corresponding to the initiation of a first application;
program code instructions for initiating the first application in response to receiving the first input;
program code instructions for receiving an indication of a closure of the first application;
program code instructions for determining that the closure of the first application occurred meeting one or more predetermined conditions; and
program code instructions for causing a recommendation to be provided of at least a second application in response to determining that the closure of the first application occurred meeting one or more predetermined conditions.

16. The computer program product according to claim 15, wherein one of the one or more of the predetermined conditions comprises that no user initiated functions of the first application were executed between the initiation of the first application and the indication of the closure of the first application.

17. The computer program product according to claim 15, wherein one of the one or more of the predetermined conditions comprises receiving an indication of a closure of the first application within a predetermined time of receiving the first input corresponding to the initiation of the first application.

18. The computer program product according to claim 15, wherein the program code instructions for causing a recommendation to be provided of at least a second application in response to determining that the closure of the first application occurred meeting one or more predetermined conditions comprises program code instructions for determining that the second application is at least one of: an application that performs a similar function as the first application, an application comprising a tile that is similar to a tile of the first application; an application with a name similar to a name of the first application, or proximity of a tile representing the first application to a tile representing the second application.

19. The computer program product according to claim 15, wherein the program code instructions for receiving an input corresponding to the initiation of a first application comprises program code instructions for receiving an indication of selection of a tile corresponding to the first application, and wherein the program code instructions for causing a recommendation to be provided of at least a second application in response to determining that the closure of the first application occurred meeting one or more predetermined conditions comprises program code instructions for providing for display of at least a tile corresponding to at least the second application.

20. The computer program product according to claim 15, further comprising program code instructions for determining that the first application had previously been closed, where the previous closure occurred meeting one or more predetermined conditions, wherein the program code instructions for causing a recommendation to be provided of at least a second application comprises program code instructions for causing a recommendation to be provided of at least a second application that corresponds to an application that was initiated in response to the first application previously being closed where the closure occurred meeting one or more predetermined conditions.
